(19) United States
(12) Patent Application Publication
(10) Pub. No.: US 2003/0052459 A1
(43) Pub. Date: Mar. 20, 2003

(54) Pipe seal assembly and method

(76) Inventors: A. William Shorey, Millington, MI (US); Anthony J. Dipzinski, Grand Blanc, MI (US)

Correspondence Address: Douglas A. Mullen, Dickinson Wright PLLC, Suite 800, 1901 L. Street, N.W., Washington, DC, 20036, US

(21) Appl. No.: 09/955,872

(22) Filed: Sep. 19, 2001

(51) Int. Cl. F16L 21/05

(52) U.S. Cl. 277/603

(57) ABSTRACT

A seal assembly for sealingly coupling a carrier pipe to a head wall comprising a reducer bushing and coupling sheet. The reducer bushing includes a circular seat with a circumference. The coupling sheet has first and second longitudinal ends, first and second sides, and a sheet length extending between the first and second ends. The sheet length at the second side being approximately equal to the circumference of the bushing seat. Selected embodiments of the invention also include a connector that is adapted to secure the first and second ends of the coupling sheet to one another. The invention is also directed to a sealed pipe structure including a head wall, a carrier pipe extending outwardly from the head wall, and the pipe seal assembly. Finally, the invention includes a method for sealing a carrier pipe to a head wall.

### BACKGROUND OF THE INVENTION

1. Technical Field

The present invention generally relates to a method and assembly for sealing a carrier pipe to a structure such as a head wall or casing.

2. Discussion

Existing infrastructure providing utility service, such as natural gas, sanitary sewer, storm water drainage, water, and electricity, commonly includes pipelines that pass into and through various structures. For example, pipelines are often buried underground and pass into or through manholes, building foundations, and the like. A variety of materials and assemblies are used to create a seal between the carrier pipe and structure to isolate the interior and exterior environments.

One such environment, illustrated in FIG. 1, includes a carrier pipe 10 passing into or through a bridge head wall 12. Storm water run-off from the bridge deck 14 and exposure to other environmental conditions causes deterioration of the head wall and the carrier pipe due to corrosion. Further, vibrations from the dynamic loading of the bridge, such as from automotive or rail traffic, resonates through the structure and the carrier pipe resulting in stresses at the pipe/head wall interface. Over time, vibration and other loadings deteriorate the pipe/head wall joints and present further avenues for corrosion causing elements to invade the head wall structure and impact the integrity of the carrier pipe.

Various techniques have evolved in the art for addressing these concerns. For example, a casing 16 may be disposed in the head wall during construction. The casing has an internal diameter greater than the outer extent of the carrier pipe. The carrier pipe is disposed within the casing and the annular void 18 between the carrier pipe and casing pipe is commonly filled with commercially available casing fillers. While such a technique provides the carrier pipe with some protection from corrosion, the portion of the casing extending outwardly from the head wall face is exposed to the elements. Over time, the casing pipe deteriorates causing a corresponding decrease in protection for the carrier pipe. Moreover, portions of the casing filler is still exposed to environmental conditions and may decrease in effectiveness over time.

To date, the above concerns have not been adequately addressed in the art. The deficiencies in the art are particularly troublesome in view of the aging infrastructure in this country. Accordingly, a need exists for a method and assembly for easily sealing a carrier pipe to a structure, such as a head wall or casing, to provide effective corrosion resistance and withstand vibration stresses, particularly those present in bridge structures. It is further desirable for the high integrity seal provided by the assembly to protect the carrier pipe (as well as the casing and casing filler) at the head wall, to be useable in new and existing structures, and to have low material and installation costs.

### SUMMARY OF THE INVENTION

In view of the above, the present invention is directed to a seal assembly for sealingly coupling a carrier pipe to a structure such as a head wall or casing. The seal assembly includes a reducer bushing having a circular seat with a circumference and a coupling sheet having first and second longitudinal ends, first and second sides, and a sheet length extending between the first and second ends. The sheet length at the second side is approximately equal to the circumference of the bushing seat. Selected embodiments of the invention also include a connector that is adapted to secure the first and second ends of the coupling sheet to one another. The invention is also directed to a sealed pipe structure including a head wall, a carrier pipe extending outwardly from the head wall, and the pipe seal assembly. Finally, the invention includes a method for sealing a carrier pipe to a head wall.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a sectional view of a representative prior art installation of a carrier pipe passing into a bridge head wall;

FIG. 2 is a sectional view of a carrier pipe passing into a bridge head wall with a first embodiment of the seal assembly of the present invention;

FIG. 3 is an upper perspective view of the seal assembly shown in FIG. 2;

FIG. 4 is a perspective view of the flange component of the seal assembly shown in FIG. 2;

FIG. 5 is a sectional view of the flange taken along the line 5-5 in FIG. 4;

FIG. 6 is a side elevational view of the bushing component of the seal assembly shown in FIG. 2 with a concentric carrier pipe hole;

FIG. 7 is a plan view of the bushing component of the seal assembly shown in FIG. 2 with a eccentric carrier pipe hole;

FIG. 8 is a top plan view of the coupling sheet component of the seal assembly shown in FIG. 2;

FIG. 9 is a sectional view taken along the line 9-9 shown in FIG. 8;

FIG. 10 is a top plan view of the connecting plate component of the seal assembly shown in FIG. 2;

FIG. 11 is a sectional view of a carrier pipe passing into a bridge head wall with a second embodiment of the seal assembly of the present invention.

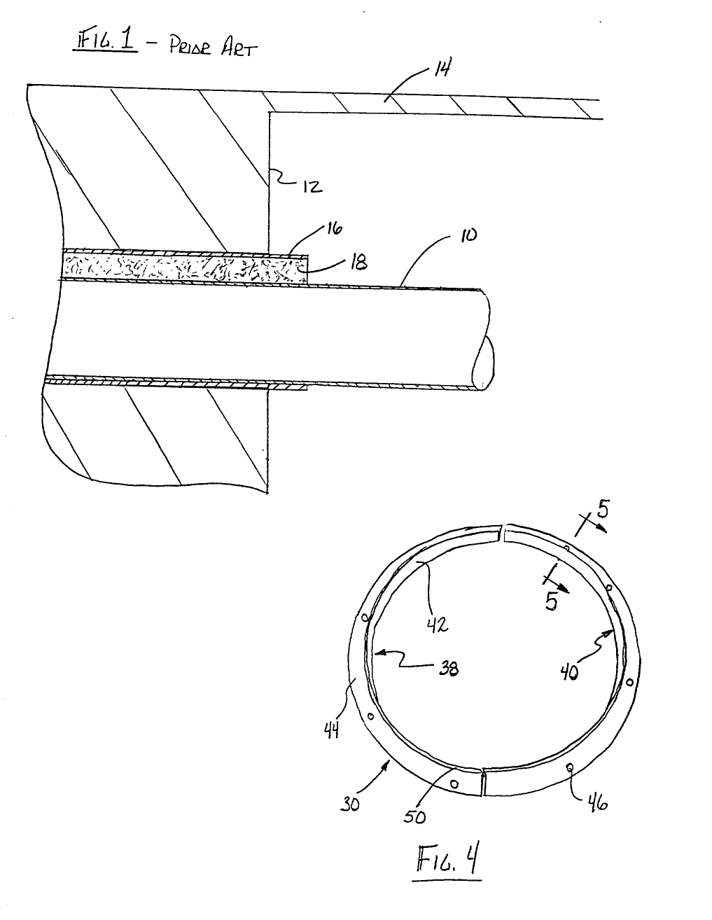

### DETAILED DESCRIPTION OF THE PREFERRED EMBODIMENT

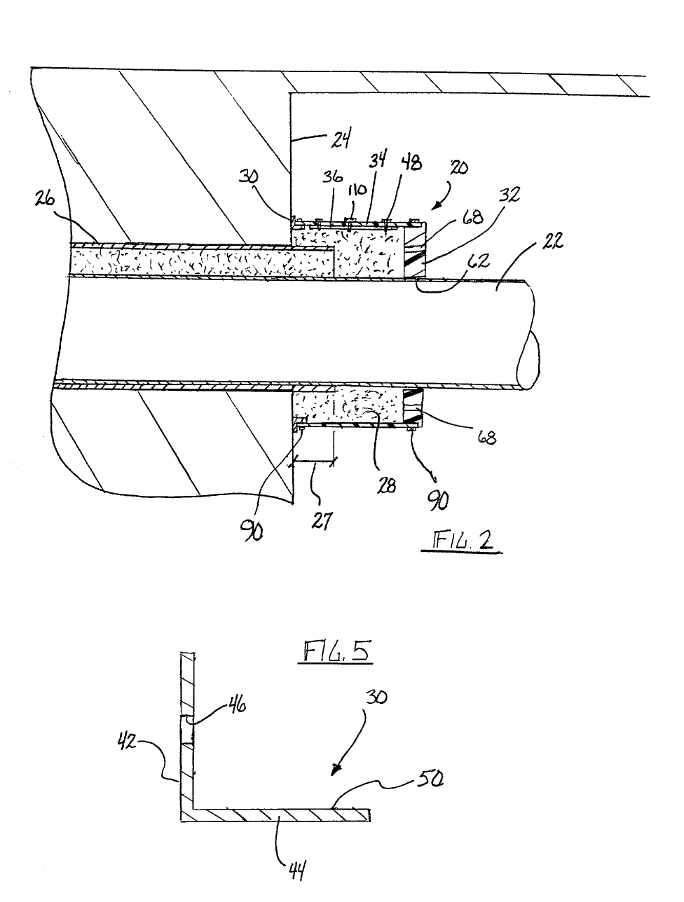

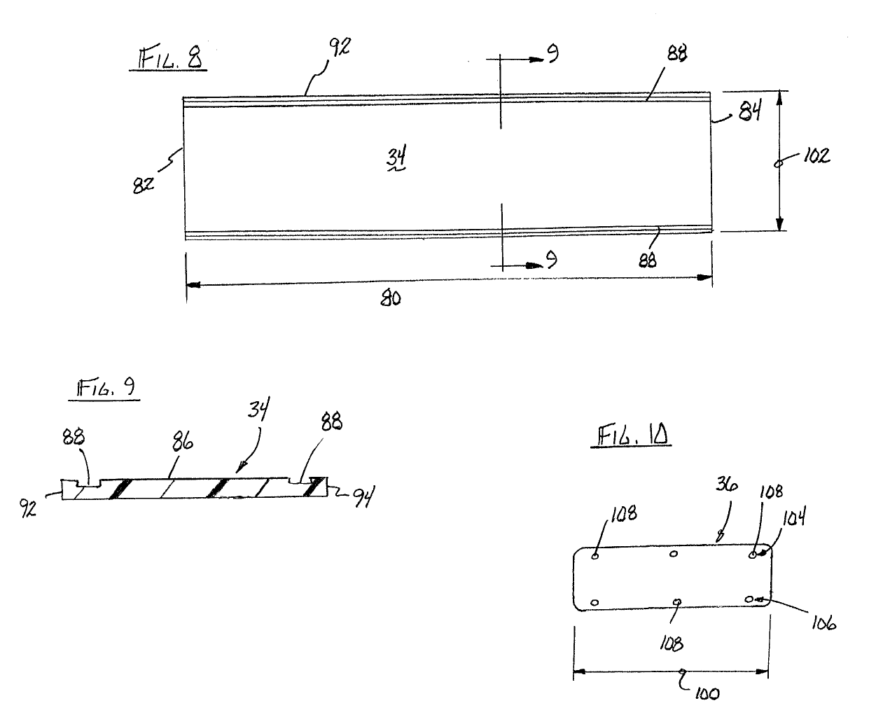

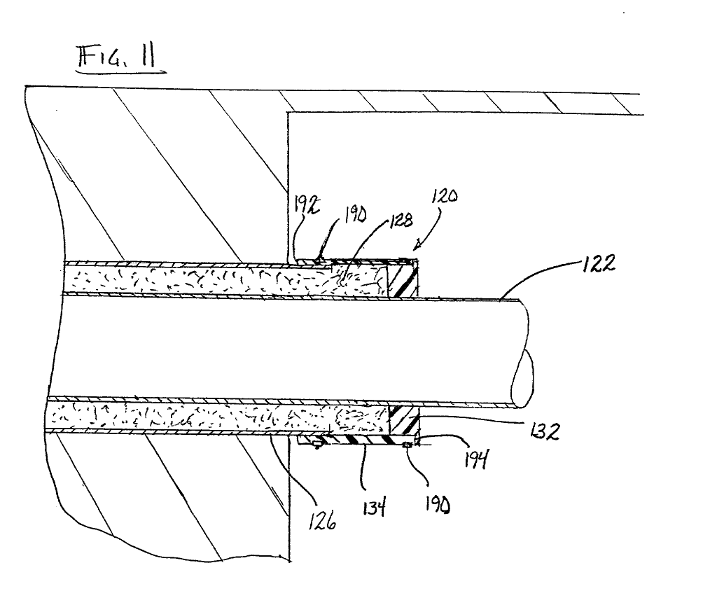

This detailed description of the present invention includes a first embodiment illustrated in FIGS. 2-10 wherein the seal assembly creates a sealed cavity between a structure head wall and the carrier pipe. The second embodiment, illustrated in FIG. 11 shows a seal assembly 120 that creates a sealed cavity between the casing and carrier pipe. As is further described below, each of the embodiments of the seal assembly have common characteristics and functionality that, when viewed in light of this description as well as the appended drawings and claims, will permit those skilled in the art to identify and implement modifications and variations without departing from the true spirit and scope of the invention as defined in the claims.

A first embodiment of the seal assembly of the present invention will now be described with particular reference to FIGS. 2-10. FIG. 2 illustrates the seal assembly 20 coupled to a carrier pipe 22 and a structure having a head wall 24. For purposes of discussion, the structure is described herein as a bridge abutment but those skilled in the art will appreciate that the seal assembly of the present invention has widespread application for various structures. In the illustrated embodiment, the carrier pipe 22 is disposed within a larger diameter casing 26 which extends a distance 27 outwardly from the head wall 24. When the seal assembly 20 is fully assembled as shown in FIGS. 2 and 3, it forms a sealed cavity 28 between the head wall 24 and the carrier pipe 22. The cavity preferably encompasses the portion of the casing 26 that extends from the head wall 24 and is filled with a casing filler, such as a corrosive resistive wax, for additional structural integrity as well as corrosion and vibration resistance.

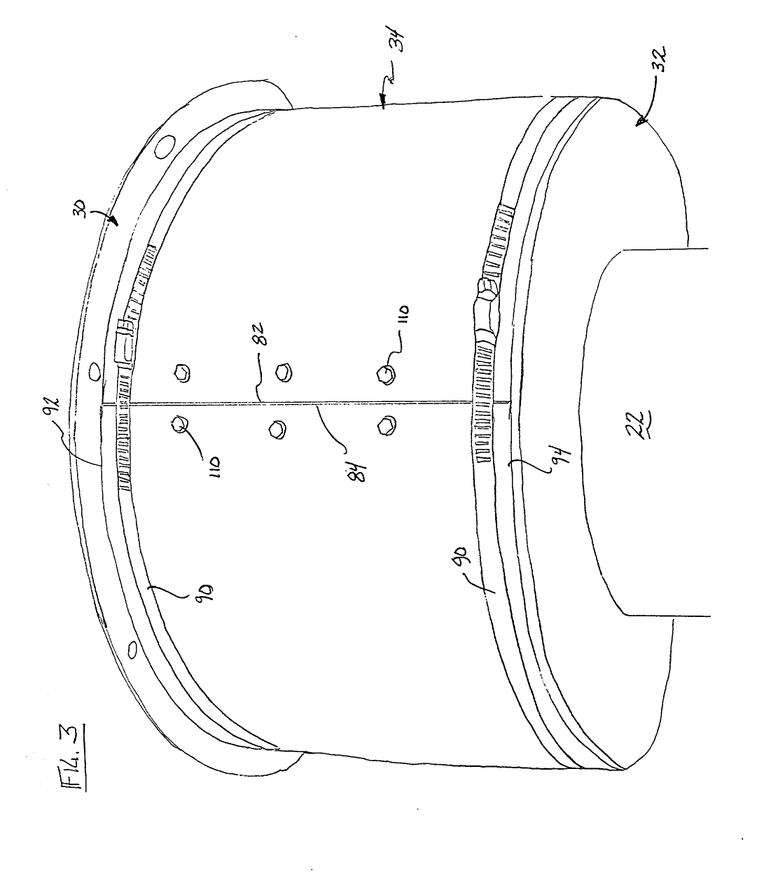

The seal assembly 20 of the present invention includes a flange 30, reducer bushing 32, coupling sheet 34, and connecting plate 36. In general, and as described in greater detail below, each of the flange, reducer bushing, and coupling sheet are configured to permit installation of the seal assembly after the carrier pipe has been disposed within the casing. For example, the flange 30 preferably includes first and second semi-circular sections 38 and 40 (FIG. 4) each having an L-shaped configuration (FIG. 5) defining a face 42 and leg 44. The flange 30 is preferably formed of a corrosion resistant material such as aluminum.

During assembly, the face 42 is fixed to the head wall 24 such as by an epoxy or other adhesive and may include holes 46 spaced therearound to accommodate fasteners, such as bolts (not shown), to further secure the flange face 42 to the head wall 24. Other suitable conventional means for connecting the flange to the head wall may be used without departing from the scope of the invention defined by the appended claims. The outer surface of the leg 44 defines a generally circular outer seat 50 having a diameter greater than the outer diameter of the carrier pipe 22 and, preferably, greater than the outer diameter of the casing 26. By this configuration, after the head wall has been cleaned and otherwise prepared to permit a proper seal, the flange sections 38 and 40 may be positioned about the casing 26 and secured to the head wall 24 such as through the use of a two-part epoxy. Those skilled in the art will appreciate that while the flange has been described herein as an aluminum flange having a circular configuration according to the applicant's preferred embodiment, other materials and configurations may be used without departing from the scope of the invention as defined by the appended claims.

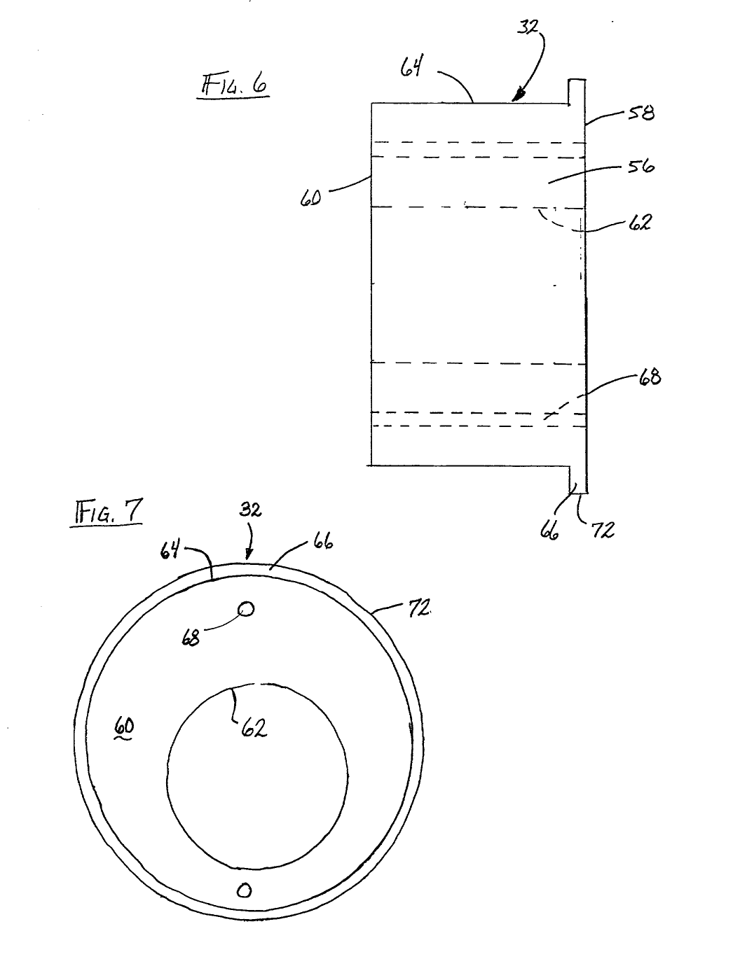

With reference to FIGS. 6 and 7, reducer bushing 32 includes a cylindrical body or ring 56 having a face 58, a back 60, an inner passage 62 extending between the face and back, an outer seat 64, a radial lip 66, and fill holes 68. A cut line 70 (FIG. 7) extends from the inner passage 62 to the outer extent 72 of the ring 56 to permit the bushing to be spread during installation and wrapped about the carrier pipe 22. The inner passage 62 has a diameter that is sized to receive the carrier pipe and provide a seal fit between the bushing and the pipe. The inner passage 62 may be positioned concentric (FIG. 6) or eccentric (FIG. 7) relative to the circular ring 56 depending upon the desired relative position of the carrier pipe 22 and casing 24.

As is described in greater detail below, the radial lip 66 acts as an assembly stop for the coupling sheet 34. The fill holes 68 provide access to the sealed cavity 28 during installation to permit injection of a casing filler. The fill holes are preferably 0.625 inch diameter holes positioned one-hundred eighty degrees (180°) apart such that the bushing may be positioned with one hole vertically below the other hole whereby the lower hole acts as the fill inlet and the upper hole as the outlet during injection of the casing filler. The bushing ring 56 is preferably formed of a molded black plasticized PVC with an initial durometer hardness of 65 on the Shore “A” scale. This material provides sufficient flexibility for ease of installation and the desired structural strength and resistance to environmental factors such as corrosion. Notwithstanding these representative dimensions and material, those skilled in the art will appreciate that the bushing of the present invention may have a variety of configurations and be formed of different material without departing from the scope of the invention as defined by the appended claims.

The coupling sheet 34 is also preferably an extruded black plasticized PVC with an initial durometer hardness of 65 on the Shore “A” scale. As is discussed in greater detail below, the coupling sheet acts as a sleeve about the carrier pipe to define the radial extent of the sealed cavity and, just like the reducer bushing 32 and flange 30, is configured to permit placement of the sheet about the carrier pipe and casing. While a variety of sheet or sleeve configurations and manufacturing techniques may be used to provide a coupling sheet of the type described herein, such as by cutting a circular sleeve similar to the cut bushing 32 or using multiple cooperating semi-circular shaped sections, the sheet 34 is preferably a generally planar and extruded element that is cut to a length 80 between its ends 82 and 84 that is approximately equal to, and preferably slightly less than, the circumference of the outer flange seat 50 and the outer bushing seat 64. The outer surface 86 of the coupling sheet includes transverse recesses 88 to receive compression clamps 90 (FIGS. 2 and 3) as hereinafter described. In order to provide the desired seal with the outer bushing seat 64 and the outer flange seat 50, the recesses 88 are positioned adjacent the sides 92 and 94 of the coupling sheet 34. During assembly, the coupling sheet is wrapped about the carrier pipe such that the sheet sides 92 and 94 rest on the flange seat 50 and bushing seat 64, respectively. In order to facilitate ease of installation, the flange and bushing seats 50 and 64 are preferably the same diameter. However, they may be of differing diameter wherein the coupling sheet would have a tapered length without departing from the invention as defined by the appended claims.

The connecting plate 36 functions as a connector to connect the ends 82 and 84 of the coupling sheet to one another. While a variety of connecting plate configurations may be used with the present invention, the connecting plate 36 described herein is preferably constructed of polypropylene and has a length 100 slightly less than the sheet width 102 between the sheet sides 92 and 94. By this configuration, the connecting plate 36 may be positioned relative to the sheet 34 so that the sheet 34 rests on the flange and bushing seats (50 and 64) without interference from the plate 36. The compression clamps 90 may then be set in the recesses 88 and tightened to provide a compression seal between the sheet 34 and the flange and bushing seats. To facilitate the alignment and connection of the plate 36 to the sheet 34, the connecting plate 36 is provided with two rows 104 and 106 of pilot holes 108. Self-tapping plated screws 110 (FIGS. 2 and 3) or other fasteners may be disposed through the sheet 34 and into the pilot holes 108 to fasten the sheet 34 to the connecting plate 36. Those skilled in the art will appreciate that the connecting plate 36 may be formed of materials other than polypropylene that provide a semi-rigid plate having the strength to adequately fix the ends 82 and 84 of the coupling sheet to one another during installation and use of the seal assembly 10.

With the above description of the components of the seal assembly in mind, the following description of the preferred method for sealing a carrier pipe to a structure using the seal assembly of the present invention is provided. While the steps of the preferred method are described herein in a predetermined sequence, those skilled in the art will appreciate that the sequence may be varied without departing from the scope of the invention defined by the appended claims.

In the preferred embodiment, the installation is initiated by preparing the concrete wall for coupling of the flange 30 such as by cleaning and otherwise removing surface imperfections and debris. A two-part epoxy, such as the Fas Metal fast curing epoxy distributed by ITW Devcon of Danvers, Mass., is then applied to the seal face 42 of each semicircular half 38 and 40 of the flange. The flange halves are positioned about the casing and attached to the head wall 24 by the epoxy. The reducer bushing 32 is placed about the carrier by spreading the bushing 32 about its cut line 70. The coupling sheet 34 is wrapped about the carrier pipe and the connecting plate 36 is used to connect the sheet ends 82 and 84 to one another such as by screws 110 disposed within the pilot holes 108. The first side 92 of the coupling sheet is placed about the outer seat 50 of the flange 30 and one of the compression clamps 90 is disposed within the appropriate recess 88 of sheet 34 and tightened, preferably to a force of approximately sixty inch-pounds. The reducer bushing is axially slid along the carrier pipe until the coupling sheet 34 is in operative engagement with the bushing seat 64, preferably such that the radial lip 66 abuts the second side 94 of the coupling sheet 34. Another compression clamp 90 is placed within the appropriate recess 88 and tightened, again preferably to approximately sixty inch-pounds, to provide a seal between the coupling sheet 34 and reducer bushing 32.

As noted above, the reducer bushing is preferably oriented relative to the carrier pipe such that one of the fill holes 68 is positioned vertically below the other fill hole. A casing filler, preferably a corrosion resistant wax, may include a variety of commercially available fillers including fill-coat No. 2 (cold-installed casing filler) distributed by the Trenton Corporation of Ann Arbor, Mich., the type 1 or type 31 G Denso employed filler (injectable petrolatum compound) distributed by Denso North America Inc. of Toronto, Ontario, Canada and Houston, Tex., USA, and the like. The casing filler is injected in the lower fill hole until the wax flows from the top fill hole. The fill holes are then plugged such as by cork plugs 112.

It should be appreciated from the foregoing description that the present invention provides a seal assembly that is easy to install in new and existing pipe/head wall interfaces. The seal assembly provides a sealed chamber that encompasses the carrier pipe, and preferably the casing, at the interface with the head wall. As a result, the seal assembly protects the casing and carrier pipe from environmental conditions that may deteriorate the pipes and the head wall, such as corrosion, while also providing ports for injection of a casing filler into the sealed assembly cavity as well as the annular void between the carrier pipe and casing. This configuration enhances the service life of pipeline installations by addressing problems not previously recognized in the art and in a manner not previously provided.

As discussed above, the first embodiment of the invention illustrated in FIGS. 2-10 includes a flange for coupling the seal assembly 20 to the head wall 24. In a second embodiment of the present invention illustrated in FIG. 11, the invention is directed to a seal assembly 120 that creates a sealed cavity 128 between the carrier pipe 122 and casing 126. The seal assembly 120 of this second embodiment includes substantially all of the components discussed above other than the flange 30 and connecting plate 36. In this embodiment, the seal assembly 120 includes a coupling sheet 134 having a first side 192 that is sealingly coupled to the exterior diameter of the casing 126, such as via a compression clamp 190, and a second side 194 that is sealingly coupled to the outer bushing seat in the manner described above.

As noted above, the second embodiment of the invention is shown without any connecting plate 36. However, those skilled in the art will appreciate that a connecting plate may be used with the second embodiment. However, for completeness, the second embodiment is illustrated to show the two ends of the coupling sheet maintained proximate to one another by the compression clamps 190 and any gap between the sheet ends being filled by the casing filler. The gap is preferably positioned at the top of the seal assembly to permit filling of the cavity 128 by the casing filler. Other than the preceding variations from the first disclosed embodiment, the second embodiment includes components of the same or substantially the same configuration and function as those described with reference to the first embodiment.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A seal assembly for sealingly coupling a carrier pipe to a structure such as a head wall or casing, comprising:
a reducer bushing having a circular seat with a circumference, a body with a face and a back, an inner passage extending from said face to said back, and a cut extending radially from said inner passage to the outer extent of the body; and
a coupling sheet having first and second longitudinal ends, first and second sides, and a sheet length extending between said first and second ends, said sheet length at said second side being approximately equal to the circumference of the bushing seat to permit said second side to sealingly engage said circular bushing seat when said first end of said coupling sheet is connected to said second end of said coupling sheet.

2. The seal assembly of claim 1 further including a connector adapted to secure said first end of said coupling sheet to said second end of said coupling sheet.

3. The seal assembly of claim 2 wherein said connector includes a plate and a plurality of fasteners, one of said plurality of fasteners being connectable to said plate and said sheet proximate said first end, another of said plurality of fasteners being connectable to said plate and said sheet proximate said second end.

4. The seal assembly of claim 3 wherein said plate includes first and second pilot holes, one of said plurality of fasteners being disposable in said first pilot hole and connectable to said coupling sheet proximate said first sheet end, another of said plurality of fasteners being disposable in said second pilot hole and connectable to said coupling sheet proximate to said second end.

5. The seal assembly of claim 1 wherein said bushing includes fill holes extending from said face to said back, spaced from the center of said circular body, and oriented with approximately 180 degrees of separation.

6. The seal assembly of claim 2 further including a flange having a circular seat with a circumference.

7. The seal assembly of claim 6 wherein said flange includes first and second semicircular sections, said first and second sections having similar cross sectional configuration and being abuttable to define said flange.

8. The seal assembly of claim 7 wherein said sheet length is no greater than the larger of said flange seat circumference and said bushing seat circumference, wherein said first side of said coupling sheet is adapted to engage said flange seat and said second end is adapted to engage said bushing seat, and wherein said pipe seal assembly further includes clamps disposable about said sheet sides and said seats to compressibly seal said sides against said seats.

9. A sealed pipe interface comprising:
a structure having a circular seat;
a carrier pipe extending outwardly from the structure; and
a seal assembly including,
a reducer bushing having a circular seat with a circumference, a body with a face and a back, an inner passage extending from said face to said back, and a cut extending radially from said inner passage to the outer extent of said body, said carrier pipe disposed in said inner passage, and
a coupling sheet having first and second longitudinal ends, first and second sides, and a sheet length extending between said first and second ends, said first side sealingly engaging said circular structure seat and said second side sealingly engaging said bushing seat, said first and second ends being sealed to one another so that the coupling sheet and bushing define a cavity about the carrier pipe and outward from the structure.

10. The sealed pipe interface of claim 9 wherein the seal assembly further includes a connector fixed to the first and second coupling sheet ends.

11. The seal pipe interface of claim 9 wherein said seal assembly further includes a flange sealingly fixed to the structure and having a leg defining the circular structure seat.

12. The sealed pipe interface of claim 9 further including a casing having an outer circumference, said carrier pipe disposed in said casing, said outer circumference of said casing defining the circular structure seat.

13. A sealed pipe interface, comprising:
a head wall;
a carrier pipe extending outwardly from said head wall; and
a seal assembly including
a flange sealingly fixed to the head wall and having a circular seat extending therefrom, said circular seat having a circumference,
a reducer bushing having a circular seat with a circumference, a body with a face and a back, an inner passage extending through the body, and a cut extending radially from said inner passage to the outer extent of the body, said carrier pipe disposed in said inner passage,
a connector, and
a coupling sheet having first and second sides and first and second longitudinal ends, first and second sides, and a sheet length extending between said first and second ends, said first side sealingly engaging said flange seat and said second side sealingly engaging said bushing seat, said first and second ends being fixed to said connector so that said coupling sheet and bushing define a cavity about said carrier pipe and outward from the head wall.

14. The sealed pipe interface of claim 13 further including a casing extending into said head wall and a second segment extending outwardly from said head wall, said carrier pipe disposed in and extending outwardly from said opening, said cavity encompassing the second segment and opening.

15. The sealed pipe interface of claim 13 wherein said reducer bushing further includes first and second fill holes extending through said body.

16. The sealed pipe interface of claim 15 wherein said first and second fill holes are spaced from the center of said body, wherein the first fill hole is spaced approximately 180 degrees from said second fill hole, and wherein the reducer bushing is oriented to position the second fill hole substantially vertically below the first fill hole.

17. The sealed pipe interface of claim 15 wherein said connector includes a connecting plate and a plurality of fasteners, one of said plurality of fasteners connected to said plate and said sheet proximate said first end, another of said plurality of fasteners connected to said plate and said sheet proximate said second end.

18. The sealed pipe interface of claim 17 wherein said plate includes first and second pilot holes, said one of said plurality of fasteners being disposed in said first pilot hole, said another of said plurality of fasteners being disposed in said second pilot hole.

19. The sealed pipe interface of claim 13 wherein said flange includes first and second semicircular sections, said first and second sections having similar cross sectional configuration and being abutted to define said flange.

20. The sealed pipe interface of claim 13 wherein said coupling sheet further includes first and second sides and a sheet width extending between said first and second sides, wherein said connector has a length less than said sheet width, wherein said first side of said coupling sheet engages said flange seat and said second side engages said bushing seat, and wherein said pipe seal assembly further includes clamps disposed about said sheet sides and said seats to compressibly seal said sides against said seats.

21. A method for sealing a carrier pipe to a head wall with a carrier pipe extending outwardly from the head wall, the sealing assembly including a flange, a bushing, a coupling sheet, and a connector, the flange having a circular seat, the bushing having a circular body with a face and a back, a passage extending from the face to the back, a cut extending radially from the passage to the outer extent of the circular body, and a circular seat, the coupling sheet having first and second longitudinal ends, a sheet length extending between the first and second ends, the sheet length being approximately equal to the bushing seat circumference, said method comprising:
fixing the flange to the head wall;
wrapping the bushing around the carrier pipe to dispose the carrier conduit through the passage;
wrapping the coupling sheet around the carrier pipe;
fixing the first and second ends of the coupling sheet to the connector;
placing the first side of the coupling sheet into engagement with the flange seat;
placing the bushing seat into engagement with the second end of the coupling sheet;
clamping the first side of the coupling sheet against the flange seat to create a seal therebetween; and
clamping the second side of the coupling sheet against the bushing seat to create a seal therebetween and a cavity about the carrier pipe and outward from the head wall.

22. The method of claim 21 wherein the bushing further includes a first fill hole extending through said body and communicating with said cavity and wherein the method further includes injecting a casing filler through the fill hole and into the cavity.

23. The method of claim 22 wherein the bushing further includes a second fill hole extending through said body, oriented 180 degrees opposite said first fill hole, and communicating with said cavity, wherein the step of placing the bushing seal into engagement with the second side of the coupling sheet includes orienting the bushing so that the second fill hole is substantially vertically below the first fill hole, and wherein the step of injecting a casing filler through the first fill hole and into the cavity includes injecting the casing filler until the material flows from the second hole.

24. The method of claim 23 further including plugging the first and second fill holes.

25. The method of claim 21 wherein the flange includes first and second semicircular flange sections and wherein the step of fixing the flange to the head wall includes orienting the first and second flange sections relative to one another to align the flange seats to define a generally circular flange seat, applying an epoxy to the first and second flange sections or the head wall, and permitting the epoxy to secure the flange to the head wall.
